(19) United States
(12) Patent Application Publication
(10) Pub. No.: US 2024/0191767 A1
(43) Pub. Date: Jun. 13, 2024

(54) END MEMBER ASSEMBLIES AS WELL AS GAS SPRING ASSEMBLIES INCLUDING SAME

(71) Applicant: Firestone Industrial Products Company, LLC, Nashville, TN (US)

(72) Inventors: Michael F. Schweisthal, Nashville, TN (US); Pawel Wojtkowiak, Velp (NL); Bradley W. Hayes, Pendleton, IN (US); Jan van Aartsen, Arnhem (NL); Alexandru-Radu Ari, Elst (NL)

(21) Appl. No.: 18/554,786

(22) PCT Filed: May 3, 2022
(86) PCT No.: PCT/US2022/027462

§ 371 Date: Oct. 10, 2023

Related U.S. Application Data
(60) Provisional application No. 63/183,614, filed on May 3, 2021.

(51) Int. Cl. F16F 9/04; F16F 9/05

(52) U.S. Cl. CPC F16F 9/0454; F16F 9/0472; F16F 9/05; F16F 2230/30

(57) ABSTRACT

An end member assembly (EMI) with a longitudinal axis is securable to a flexible spring member (400). The end member assembly (EMI) has first and second ends. The end member assembly (EMI) includes first end member component (500) with a first component wall (502) includes an end wall portion (504) and a side wall portion (506). A second end member component (600) extends peripherally around and is permanently attached to the first end member component (500). The second end member component (600) includes a second component wall (602) with an outer surface portion (604). In some cases, the side wall portion (506) of the first component wall includes a plurality of first annular ribs (524) extending radially outward. The second component wall (602) includes a plurality of second annular ribs (612) extending radially inward. The pluralities of first and second annular ribs (524, 612) are axially interleaved with one another. Gas spring assemblies, gas spring and damper assemblies and methods of assembly are also included.

### BACKGROUND

The subject matter of the present disclosure broadly relates to the art of gas spring devices and, more particularly, to end member assemblies for gas spring assemblies. The end member assemblies can include two end member sections. In some cases, one end member section can be injection molded or otherwise formed from a polymeric material over or around the other end member section such that the two end member sections are permanently assembled with one another. Such end member assemblies can, optionally, include a plurality of interleaved annular ribs that substantially inhibit axial displacement of the two end member sections relative to one another. Gas spring assemblies including one or more of such end member assemblies are also included. In some cases, such gas spring assemblies can be assembled coextensively with damper assemblies to form gas spring and damper assemblies. Additionally, vehicle suspension systems including one or more of such gas spring assemblies (and/or gas spring and damper assemblies) are included.

The subject matter of the present disclosure may find particular application and use in conjunction with components for wheeled vehicles, and will be shown and described herein with reference thereto. However, it is to be appreciated that the subject matter of the present disclosure is also amenable to use in other applications and environments, and that the specific uses shown and described herein are merely exemplary. For example, the subject matter of the present disclosure could be used in connection with gas spring assemblies of non-wheeled vehicles, support structures, height adjusting systems and actuators associated with industrial machinery, as well as components thereof and/or other such equipment. Accordingly, the subject matter of the present disclosure is not intended to be limited to use associated with suspension systems of wheeled vehicles.

Wheeled motor vehicles of most types and kinds include a sprung mass, such as a body or chassis, for example, and an unsprung mass, such as two or more axles or other wheel-engaging members, for example, with a suspension system disposed therebetween. Typically, a suspension system will include a plurality of spring devices as well as a plurality of damping devices that together permit the sprung and unsprung masses of the vehicle to move relative to one another in a somewhat controlled manner. Movement of the sprung and unsprung masses toward one another is normally referred to in the art as jounce motion while movement of the sprung and unsprung masses away from one another is commonly referred to in the art as rebound motion.

Generally, the plurality of spring devices function to accommodate forces and loads associated with the operation and use of the vehicle. The plurality of damping devices are operative to dissipate energy associated with undesired inputs and movements of the sprung mass, such as road inputs occurring under dynamic operation of a vehicle, for example. In many cases, the damping devices can be liquid-filled, hydraulic dampers of a known construction (e.g., a conventional shock absorber or strut). In other cases, however, the damping devices can be of a type and kind that utilize gaseous fluid rather than liquid as the working medium.

In many applications involving vehicle suspension systems, it may be desirable to utilize spring elements that have as low of a spring rate as is practical, as the use of lower spring rate elements can provide improved ride quality and comfort compared to spring elements having higher spring rates. That is, it is well understood in the art that the use of spring elements having higher spring rates (i.e., stiffer springs) will transmit a greater magnitude of road inputs into the sprung mass of the vehicle and that this typically results in a rougher, less-comfortable ride. Whereas, the use of spring elements having lower spring rates (i.e., softer, more-compliant springs) will transmit a lesser amount of road inputs into the sprung mass and will, thus, provide a more comfortable ride.

In some cases, the spring devices of vehicle suspension systems will include springs that utilize pressurized gas as the working medium of the devices. Generally, it is possible to reduce the spring rate of gas springs, thereby improving ride comfort, by increasing the volume of pressurized gas operatively associated with the gas spring. This is commonly done by utilizing an end member that defines an additional chamber, cavity or volume filled with pressurized gas in fluid communication with the primary spring chamber of the gas spring. However, end members of this type can be challenging to manufacture as a single unitary component. Thus, in many cases, such end members are assembled from multiple components that are secured together such that a substantially fluid-tight joint is formed therebetween.

Unfortunately, many assembly techniques that are currently used to manufacture such multi-component end members suffer from elevated manufacturing costs, such as may be due to the inclusion and installation of seals and/or the manipulation and handling of components during the joining process. Additionally, in some cases, generating and maintaining robust and substantially fluid-tight joints between components can be challenging and can sometimes lead to undesirable pressurized gas loss or other decreases in performance characteristics of the resulting assembly. Accordingly, it is believed desirable to develop constructions and manufacturing techniques that may aid in overcoming the foregoing and/or other disadvantages associated with known end member assemblies, and/or otherwise advance the art of vehicle suspension systems and/or components thereof.

### BRIEF DESCRIPTION

One example of an end member assembly in accordance with the subject matter of the present disclosure can have a longitudinal axis and can be dimensioned for securement to an associated flexible spring member. The end member assembly can extend axially from a first end toward a second end. The end member assembly can include a first end member component with a first component wall that extends peripherally about the longitudinal axis. A second end member component can include a second component wall formed as a unitary mass that extends continuously and uninterrupted (i.e., endlessly) around the periphery of the first end member component such that the second end member component is permanently attach to the first end member component.

In some cases, the first component wall can include an end wall portion oriented transverse to the longitudinal axis and a side wall portion extending axially from along the end wall portion. The second component wall can extend continuously around and axially coextensively along the side wall portion of the first component wall.

In some cases, the first component wall can include a first plurality of annular ribs disposed in axially-spaced relation to one another. Additionally, or in the alternative, the second component wall can include a second plurality of annular ribs that are disposed in axially spaced relation to one another. In cases in which both the first plurality of annular ribs and the second plurality of annular ribs are included, one of the second plurality of annular ribs can be axially disposed between adjacent ones of the first plurality of annular ribs such that the first and second pluralities of annular ribs are axially interleaved with one another.

In some cases, the side wall portion of the first component wall can include an inner surface portion and an outer surface portion with the first plurality of annular ribs projecting radially outward from along the outer surface portion.

In some cases, the end member assembly can include a third end member component that is at least partially embedded within the first end member component.

One example of a gas spring assembly in accordance with the subject matter of the present disclosure can have a longitudinal axis and can include a flexible spring member extending peripherally about the longitudinal axis and longitudinally between opposing first and second ends such that a spring chamber is at least partially defined therebetween. A first end member assembly according to any one or more of the foregoing paragraphs can be operatively secured across the first end of the flexible spring member such that a substantially fluid-tight connection is formed therebetween. A second end member can be operatively secured across the second end of the flexible spring member such that a substantially fluid-tight connection is formed therebetween.

One example of a gas spring and damper assembly in accordance with the subject matter of the present disclosure can include a gas spring assembly according to the foregoing paragraph and a damper assembly with the gas spring assembly disposed in axially coextensive relation with at least a portion of the damper assembly.

One example of a suspension system in accordance with the subject matter of the present disclosure can include a pressurized gas system that includes a pressurized gas source and a control device. The suspension system can also include at least one gas spring assembly and/or at least one gas spring and damper assembly according to either of the two foregoing paragraphs. The at least one gas spring assembly and/or gas spring and damper assembly can be disposed in fluid communication with the pressurized gas source through the control device such that pressurized gas can be selectively transferred into and out of the spring chamber.

One example of a method of manufacturing an end member assembly in accordance with the subject matter of the present disclosure can include injecting a first quantity of polymeric material into a first mold cavity at least partially defined by first and second first mold sections thereby forming a first end member component having a longitudinal axis. The method can also include injecting a second quantity of polymeric material into a second mold cavity at least partially defined by the first end member component and a third mold section with the first end member component supported on at least one of the first and second mold sections thereby molding a second end member component extending continuously and uninterrupted (i.e., endlessly) around the periphery of the first end member component such that the second end member component is permanently attach to the first end member component.

### BRIEF DESCRIPTION OF THE DRAWINGS

FIG. 1 is a schematic representation of one example of a suspension system of an associated vehicle that includes one or more gas spring assemblies in accordance with the subject matter of the present disclosure.

FIG. 2 is a side elevation view of one example of a gas spring and damper assembly including an exemplary gas spring assembly in accordance with the subject matter of the present disclosure.

FIG. 3 is a top plan view of the exemplary gas spring and damper assembly in FIG. 2.

FIG. 4 is an enlarged side elevation view of the exemplary gas spring and damper assembly in FIGS. 2 and 3 taken from along line 4-4 in FIG. 3.

FIG. 5 is a cross-sectional side elevation view of the exemplary gas spring and damper assembly in FIGS. 2-4 taken from along line 5-5 in FIG. 3.

FIG. 6 is a cross-sectional bottom view of the exemplary gas spring and damper assembly in FIGS. 2-5 taken from along line 6-6 in FIG. 4.

FIG. 7 is an enlarged view of the portion of the exemplary gas spring and damper assembly in FIGS. 2-6 identified as Detail 7 in FIG. 5.

FIG. 8 is a top perspective view of one example of an end member assembly in accordance with the subject matter of the present disclosure, such as is shown in FIGS. 2-7, for example.

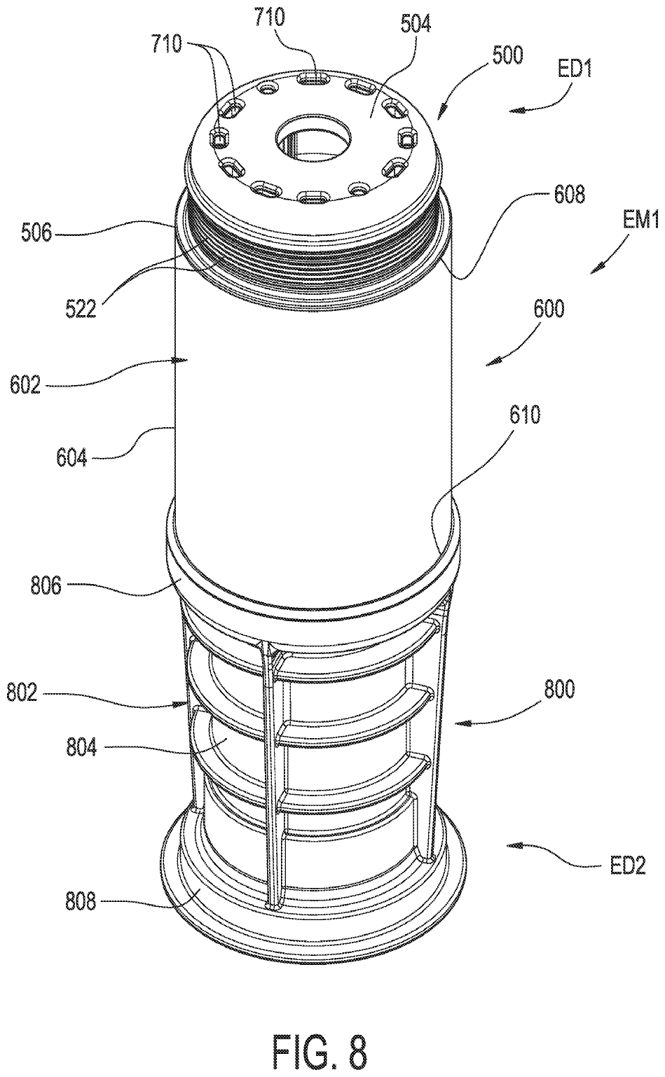

FIG. 9 is a top plan view of the exemplary end member assembly in FIGS. 2-8.

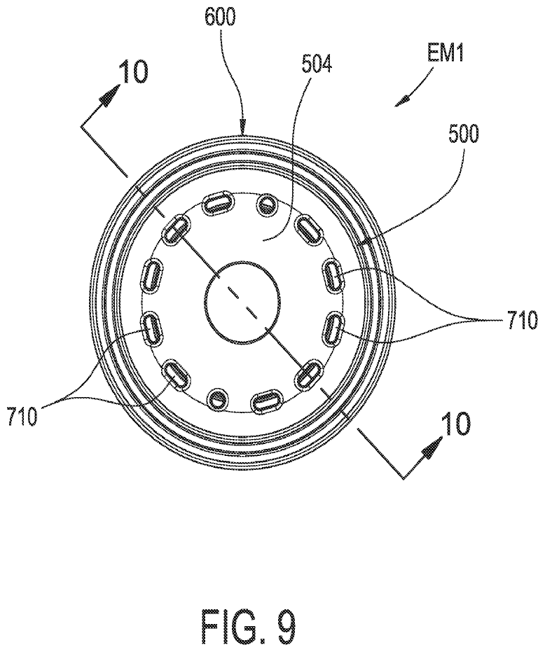

FIG. 10 is a cross-sectional side-elevation view of the exemplary end member assembly in FIGS. 2-9 taken from along line 10-10 in FIG. 9.

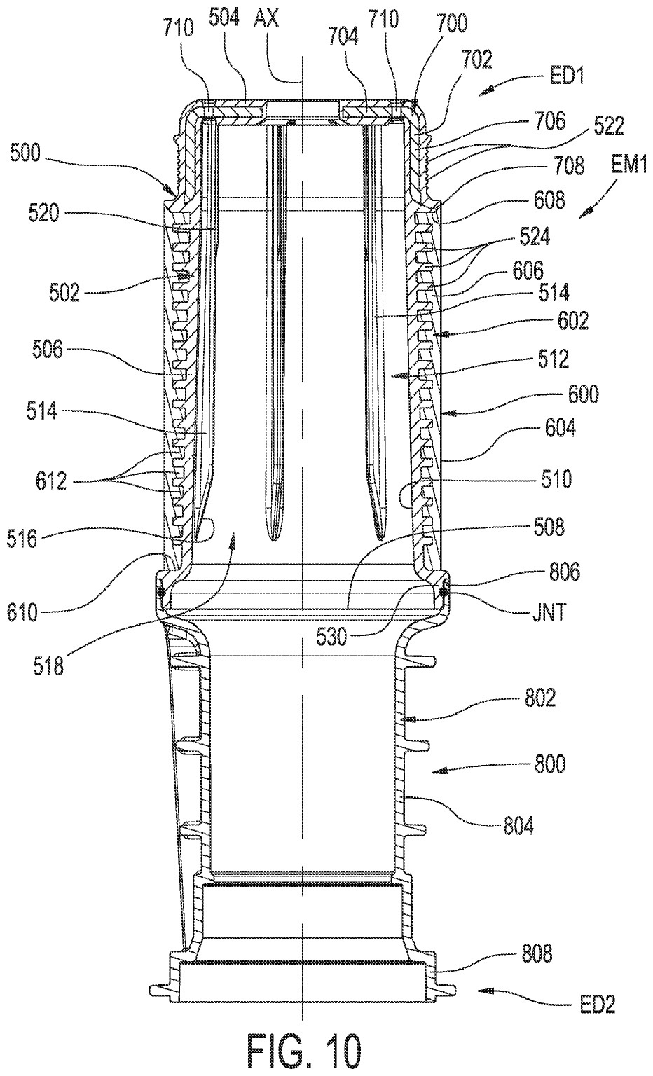

FIG. 11 is a cross-sectional side elevation view one end member component of FIGS. 2-10 supported in a first mold cavity formed by a plurality of mold sections prior to forming another end member component.

FIG. 12 is the cross-sectional side elevation view of FIG. 11 showing the one end member component at least partially embedded within the other end member component formed within the first mold cavity in FIG. 11 with some of the plurality of mold sections of FIG. 11 removed and with the one and/or other end member components remaining disposed in situ in one or more remaining mold sections.

FIG. 13 is the cross-sectional side elevation view of FIG. 12 showing the one and the other end member components remaining in situ on the remaining mold sections and disposed within a second mold cavity formed around the one and the other end member components by additional mold sections for in situ manufacture of a further end member component around the one and/or the other end member components.

FIG. 14 is an exploded cross-sectional side view of the end member assembly in FIGS. 8-13 with the one, the other and the further end member components shown prior to assembly with still another end member component.

### DETAILED DESCRIPTION

Turning now to the drawings, it is to be understood that the showings are for purposes of illustrating examples of the subject matter of the present disclosure and that such examples are not intended to be limiting. Additionally, it will be appreciated that the drawings are not to scale and that portions of certain features and/or components may be exaggerated for purposes of clarity and/or ease of understanding.

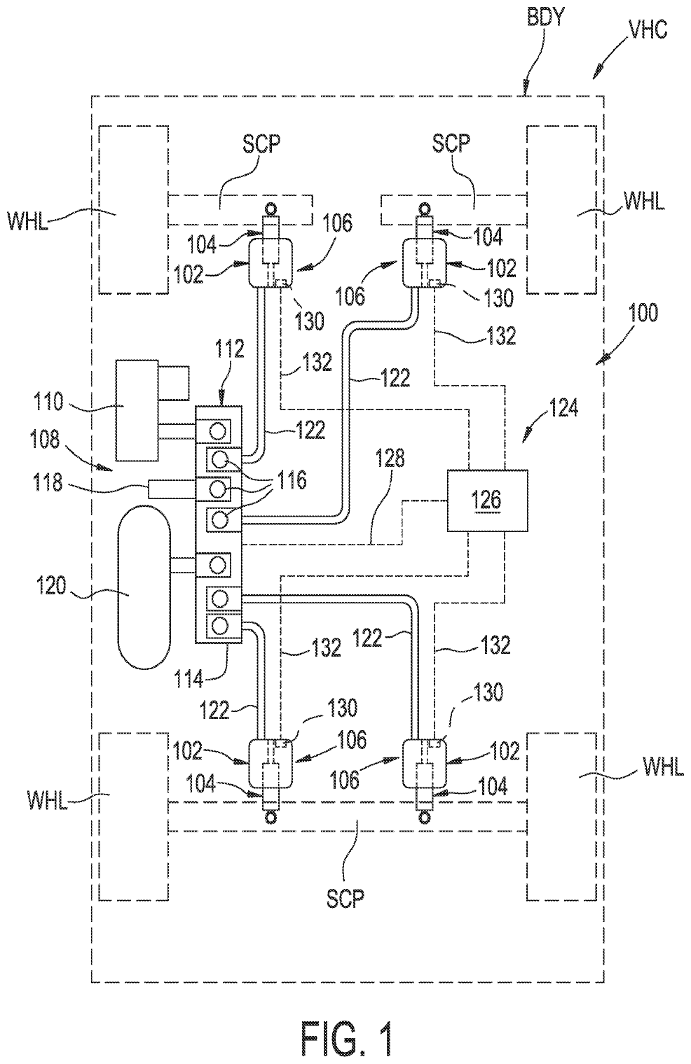

FIG. 1 illustrates one example of a suspension system 100 operatively disposed between a sprung mass, such as an associated vehicle body BDY, for example, and an unsprung mass, such as associated wheels WHL and/or associated suspension components SCP, for example, of an associated vehicle VHC. It will be appreciated that any one or more of the components of the suspension system can be operatively connected between the sprung and unsprung masses of the associated vehicle in any suitable manner. The suspension system includes one or more gas spring assemblies in accordance with the subject matter of the present disclosure as well as one or more damper assemblies that are operatively connected between the sprung and unsprung masses and together permit the sprung and unsprung masses of the associated vehicle to move in a somewhat controlled manner relative to one another, as discussed above.

Depending on desired performance characteristics and/or other factors, the one or more gas spring assemblies can, in some cases, be provided and installed separately from the one or more damper assemblies. Additionally, or in the alternative, a gas spring assembly can be assembled together with a damper assembly such that at least a portion of the gas spring assembly is axially coextensive with the damper assembly to form so-called gas spring and damper assemblies. It will be appreciated that gas spring assemblies and components thereof in accordance with the subject matter of the present disclosure are shown and described herein with particular reference to gas spring and damper assemblies. It is to be recognized and understood, however, that such a construction is optional and that gas spring assemblies in accordance with the subject matter of the present disclosure (as well as the components and assemblies thereof) are not intended to be limited to use in gas spring and damper assemblies.

As shown in FIG. 1, suspension system 100 can include a plurality of gas spring assemblies 102 that are operatively connected between the sprung and unsprung masses of the vehicle. Additionally, suspension system 100 can include a plurality of damper assemblies 104 that are operatively connected between the sprung and unsprung masses of the vehicle. Depending on desired performance characteristics and/or other factors, the suspension system can include any suitable number of one or more gas spring assemblies and one or more damper assemblies. Furthermore, the one or more gas spring assemblies and the one or more damper assemblies can be operatively connected on, along or otherwise between the sprung and unsprung masses in any suitable manner. As one non-limiting example, gas spring assembly 102 and damper assembly 104 can, optionally, be operatively connected in an axially-coextensive arrangement to form one or more gas spring and damper assemblies 106 that can then be operatively connected on, along or otherwise between the sprung and unsprung masses as a unit.

In the arrangement shown in FIG. 1, for example, suspension system 100 includes four gas spring and damper assemblies 106, one of which is disposed toward each corner of the associated vehicle adjacent a corresponding wheel WHL. It will be appreciated, however, that any other suitable number of gas spring assemblies and/or gas spring and damper assemblies could alternately be used in any other configuration and/or arrangement. As illustrated in FIG. 1, gas spring and damper assemblies 106 are supported between suspension components SCP and body BDY of associated vehicle VHC. It will be recognized that gas spring assemblies 102 are shown and described herein as being of a rolling lobe-type construction. It is to be understood, however, that gas spring assemblies of other types, kinds and/or constructions could alternately be used without departing from the subject matter of the present disclosure.

Suspension system 100 also includes a pressurized gas system 108 operatively associated with the gas spring assemblies and/or gas spring and damper assemblies for selectively supplying pressurized gas (e.g., air) thereto and selectively transferring pressurized gas therefrom. In the exemplary arrangement shown in FIG. 1, pressurized gas system 108 includes a pressurized gas source, such as a compressor 110, for example, for generating pressurized air or other gases. A control device, such as a valve assembly 112, for example, is shown as being in communication with compressor 110 and can be of any suitable configuration or arrangement. In the exemplary embodiment shown, valve assembly 112 includes a valve block 114 with a plurality of valves 116 supported thereon. Valve assembly 112 can also, optionally, include a suitable exhaust, such as a muffler 118, for example, for venting pressurized gas from the system. Optionally, pressurized gas system 108 can also include a reservoir 120 in fluid communication with compressor 110 and/or valve assembly 112 and suitable for storing pressurized gas for an extended period of time (e.g., seconds, minutes, hours, weeks, days, months).

Valve assembly 112 is in communication with gas springs 102 and/or dampers 104 of assemblies 106 through suitable gas transfer lines 122. As such, pressurized gas can be selectively transferred into and/or out of the gas springs and/or the dampers through valve assembly 112 by selectively operating valves 116, such as to alter or maintain vehicle height at one or more corners of the vehicle, for example.

Suspension system 100 can also include a control system 124 that is capable of communication with any one or more systems and/or components of vehicle VHC and/or suspension system 100, such as for selective operation and/or control thereof. Control system 124 can include a controller or electronic control unit (ECU) 126 communicatively coupled with compressor 110 and/or valve assembly 112, such as through a conductor or lead 128, for example, for selective operation and control thereof, which can include supplying and exhausting pressurized gas to and/or from gas spring and damper assemblies 106. Controller 126 can be of any suitable type, kind and/or configuration.

Control system 124 can also, optionally, include one or more sensing devices 130, such as, for example, may be operatively associated with the gas spring assemblies and/or gas spring and damper assemblies and capable of outputting or otherwise generating data, signals, information and/or other communications having a relation to one or more of: a height of gas spring assemblies and/or gas spring and damper assemblies; a distance between other components of the vehicle; a pressure or temperature having a relation to the gas spring assemblies and/or gas spring and damper assemblies and/or a wheel or tire or other component associated with the gas spring assemblies and/or gas spring and damper assemblies; and/or an acceleration, load or other input acting on the gas spring assemblies and/or gas spring and damper assemblies. Sensing devices 130 can be in communication with ECU 126, which can receive the data, signals, information and/or other communications therefrom. The sensing devices can be in communication with ECU 126 in any suitable manner, such as through conductors or leads 132, for example. Additionally, it will be appreciated that the sensing devices can be of any suitable type, kind and/or construction and can operate using any suitable combination of one or more operating principles and/or techniques.

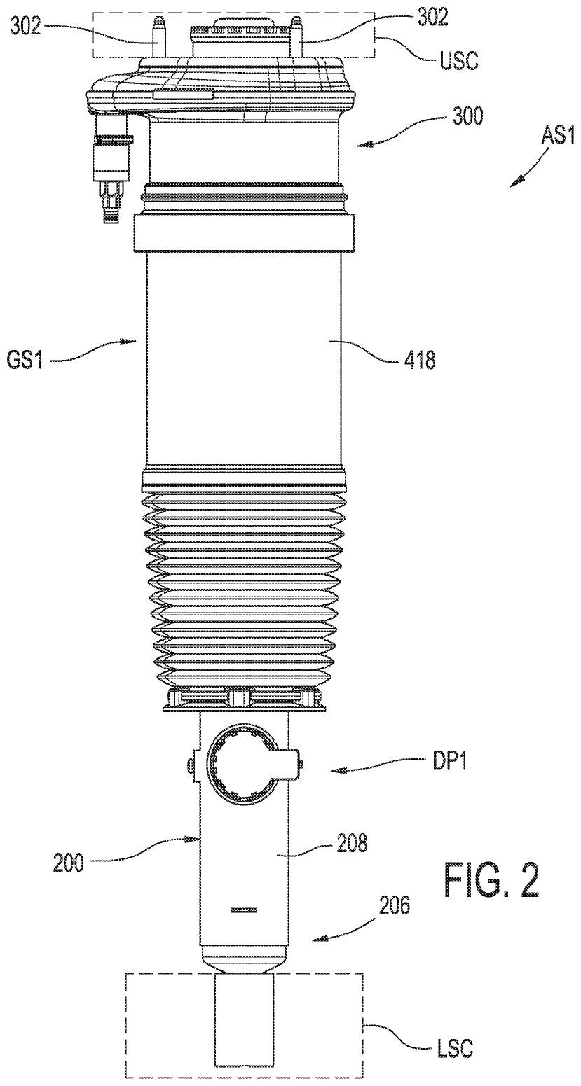

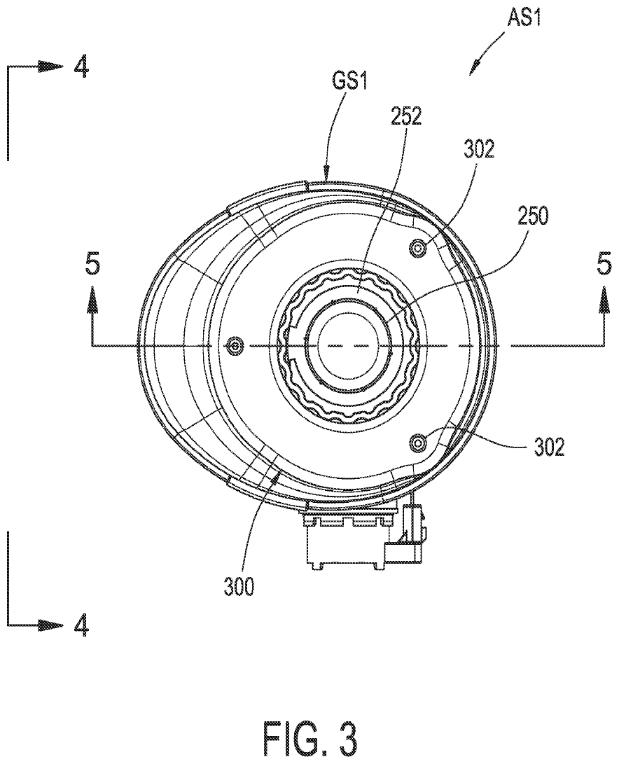

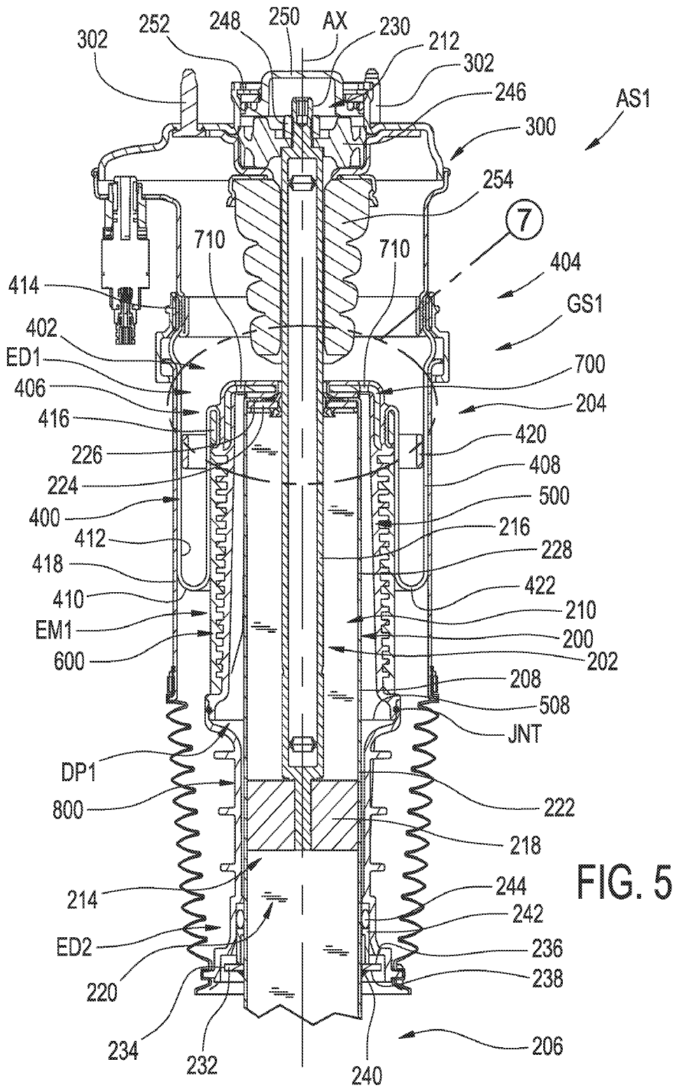

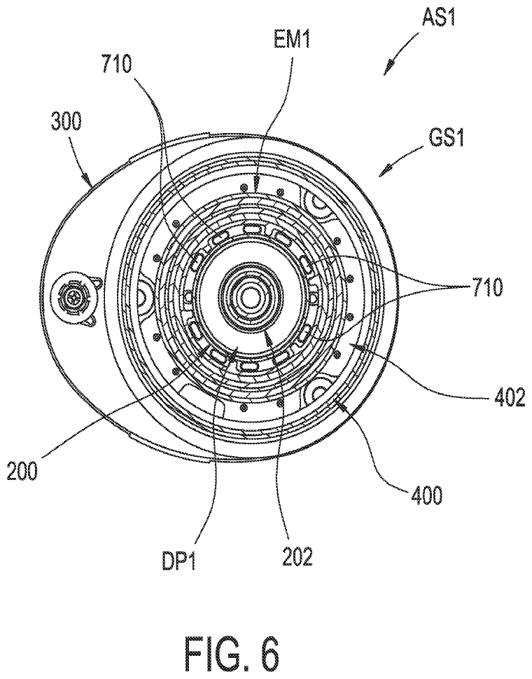

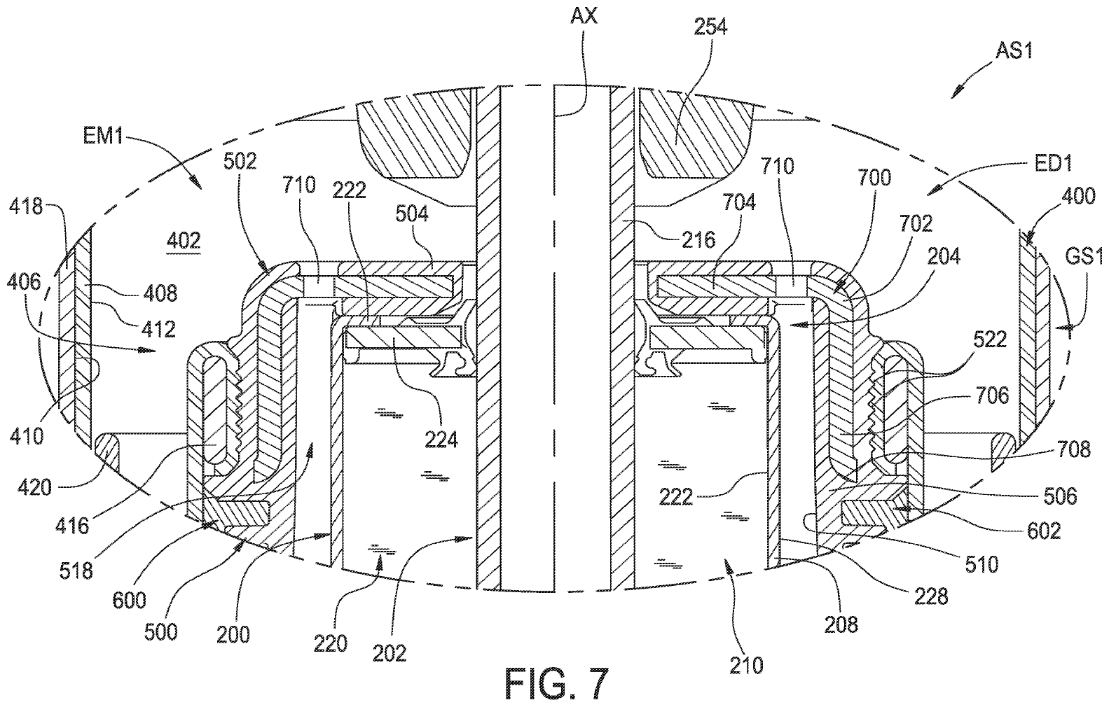

Having described an example of a suspension system (e.g., suspension system 100) that can include gas spring assemblies in accordance with the subject matter of the present disclosure, an example of a gas spring (or gas spring assembly) as well as a gas spring and damper assembly including such a gas spring assembly will now be described in connection with FIGS. 2-7. A gas spring (or gas spring assembly) GS1, such as may correspond to one of gas springs 102 in FIG. 1, for example, is shown in FIGS. 2-7. In some cases, a damper (or damper assembly) DP1, such as may correspond to one of dampers 104 in FIG. 1, for example, can be, optionally, included. In such cases, gas spring assembly GS1 and damper assembly DP1 can be disposed in a coextensive arrangement with one another. Additionally, the gas spring assembly and the damper assembly can be operatively secured to one another in a suitable manner, such as is described hereinafter, for example, to form a gas spring and damper assembly AS1, such as may be suitable for use as one or more of gas spring and damper assemblies 106 in FIG. 1. A longitudinal axis AX extends lengthwise along gas spring GS1 and/or assembly AS1, as shown in FIG. 5.

Damper assembly DP1 can include a damper housing 200 and a damper rod assembly 202 that is at least partially received in the damper housing. Damper housing 200 extends axially between housing ends 204 and 206, and includes a housing wall 208 that at least partially defines a damping chamber 210. Damper rod assembly 202 extends lengthwise between opposing ends 212 and 214 and includes an elongated damper rod 216 and a damper piston 218 operatively connected to elongated damper rod 216 along end 214 of damper rod assembly 202. Damper piston 218 is received within damping chamber 210 of damper housing 200 for reciprocal movement along the housing wall in a conventional manner. A quantity of damping fluid 220 can be disposed within damping chamber 210, and damper piston 218 can be displaced through the damping fluid to dissipate kinetic energy acting on gas spring and damper assembly AS1. Though damper assembly DP1 is shown and described herein as having a conventional construction in which a hydraulic fluid is contained within at least a portion of damping chamber 210, it will be recognized and appreciated that dampers of other types, kinds and/or constructions, such as pressurized gas or “air” dampers, for example, could be used without departing from the subject matter of the present disclosure.

Housing wall 208 can include a side wall portion 222 that extends longitudinally around longitudinal axis AX from along end 204 toward end 206. Housing wall 208 can form an opening (not numbered) along housing end 204. A damper end wall 224 can extend across the opening and can be secured on or along housing wall 218 such that a substantially fluid-tight connection is formed therebetween. In some cases, housing wall 208 can include an end wall portion 226 disposed along housing end 204 that extends radially inward from along side wall portion 222 to at least partially retain damper end wall 224 on or along the damper housing. Damper end wall 224 can include an opening (not numbered) and elongated damper rod 216 can extend axially outward from damping chamber 210 through the opening in a direction opposite housing end 206. Additionally, a damper end wall (not numbered) can be connected across end 206 of damper housing 200 such that a substantially fluid-tight connection is formed therebetween. Side wall portion 222 of housing wall 208 can include an outside surface portion 228 exposed radially outward on or along side wall portion 224 of the damper housing.

Elongated damper rod 216 can project outwardly from damper end wall 224 such that end 212 of the damper rod assembly is outwardly exposed from the damper housing and is externally accessible with respect to the damper housing. A connection structure 230, such as a plurality of threads, for example, can be provided on or along the elongated rod for use in operatively connecting gas spring and damper assembly 200, either directly or indirectly, to an associated vehicle structure, a component of gas spring assembly GS1 or another component of gas spring and damper assembly AS1.

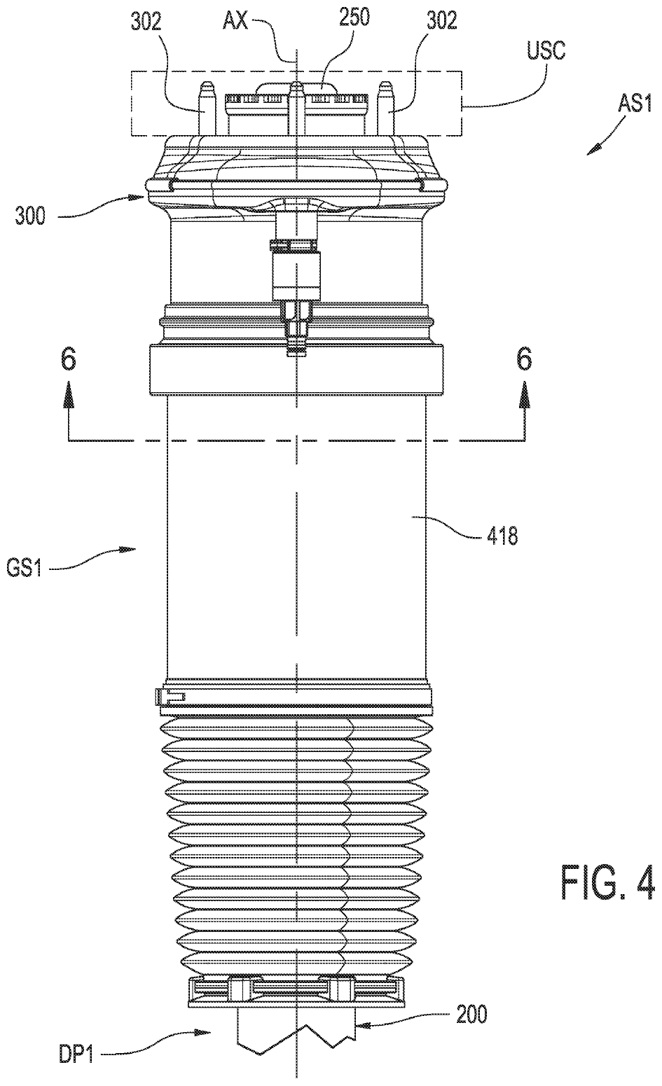

It will be appreciated that gas spring and damper assembly AS1 can be operatively connected between associated sprung and unsprung masses of an associated vehicle (or other construction) in any suitable manner. For example, one end of the assembly can be operatively connected to an associated sprung mass with the other end of the assembly disposed toward and operatively connected to an associated unsprung mass. As shown in FIGS. 2 and 4, for example, end 212 of damper rod assembly 202 can be operatively engaged (either directly or indirectly) with a first or upper structural component USC, such as associated vehicle body BDY in FIG. 1, for example, and can be secured thereon in any suitable manner. As one non-limiting example, gas spring assembly GS1 can include an end member or end member assembly 300 that can be secured to upper structural component USC and to which one or more other components of the gas spring assembly and/or one or more components of damper assembly DS1 can be operatively connected. Additionally, or in the alternative, gas spring assembly GS1 and/or damper assembly DP1 can be secured on or along a second or lower structural component LSC (FIG. 2), such as associated suspension component SCP in FIG. 1, for example, and can be secured thereon in any suitable manner.

Gas spring assembly GS1 can include a flexible spring member 400 that can extend peripherally around axis AX and can be secured between opposing end members (or end member assemblies) in a substantially fluid-tight manner such that a spring chamber 402 is at least partially defined therebetween. Flexible spring member 400 can extend axially from an end 404 toward an end 406, and can be operatively connected between the opposing end members (or end member assemblies) in any suitable manner. As a non-limiting example, end 404 of flexible spring member 400 can be secured to end member assembly 300.

Additionally, end 212 of damper rod assembly 202 can, optionally, be operatively connected to end member assembly 300. Gas spring assembly GS1 can also include an end member assembly EM1 that is supported on or along damper housing 200. End member assembly EM1 can extend axially from an end ED1 toward an end ED2 with end 406 of flexible spring member 400 secured on or along end ED1 of end member assembly EM1 in any substantially fluid-tight or otherwise suitable manner. Additionally, it will be appreciated that end member assembly EM1 can be operatively supported on or along damper housing 200 in a suitable manner, such as is described hereinafter, for example.

As a non-limiting example, end member assembly EM1 can be supported on or along end 204 of damper housing 200. In one suitable arrangement, axial forces and loads to, from and between end member assembly EM1 and damper housing 200 are at least partially transferred (directly or indirectly) to housing wall 208. As a non-limiting example, such axial forces and/or loads can be transferred (directly or indirectly) to, from and/or between end member assembly EM1 and damper housing 200 through engagement (directly or indirectly) of end wall portion 226 with end member assembly EM1 along end ED1 thereof. In this manner, end member assembly EM1 can be suspended from or otherwise axially supported along end ED1 by damper housing 200. In some cases, end ED2 of the end member assembly can, optionally, be substantially unsupported by the damper housing in the axial direction. In some cases, damper housing 200 can be adapted to provide radial support to end ED2 of end member assembly EM1, such as is described below, for example.

As a non-limiting example, damper assembly DP1 can include a support wall or support wall portion 232 that extends radially outward from along the damper housing toward an outer peripheral edge 234. Support wall portion 232 can include a surface portion 236 facing toward end 204 of damper housing 200 and a surface portion 238 facing toward end 206 of the damper housing. Support wall portion 232 can be supported on or along the damper housing in any suitable manner, such as by way of one or more flowed-material joints 240, for example. In some cases, a radial spacer or bushing 242 can be supported on or along support wall portion 232 and disposed radially between outside surface portion 228 of housing wall 208 and end ED2 of end member assembly EM1. In a preferred arrangement, radial spacer 242 can slidably engage at least one of the outside surface portion of the housing wall and a corresponding surface portion of end member assembly EM1. In some cases, a sealing device 244 can be supported on radial spacer 242 between outside surface portion 228 of housing wall 208 and end ED2 of end member assembly EM1 in space relation to support wall portion 232, such as is shown in FIG. 5, for example. It will be appreciated, however, that other configurations and/or constructions could alternately be used without departing from the subject matter of the present disclosure.

It will be appreciated that flexible spring member 400 can be of any suitable size, shape, construction and/or configuration. Additionally, the flexible spring member can be of any type and/or kind, such as a rolling lobe-type or convoluted bellows-type construction, for example. Flexible spring member 400 is shown in FIGS. 5-7 as including a flexible wall 408 that can be formed in any suitable manner and from any suitable material or combination of materials. For example, the flexible wall can include one or more fabric-reinforced, elastomeric plies or layers and/or one or more un-reinforced, elastomeric plies or layers. Typically, one or more fabric-reinforced, elastomeric plies and one or more un-reinforced, elastomeric plies will be used together and formed from a common elastomeric material, such as a synthetic rubber, a natural rubber or a thermoplastic elastomer. In other cases, however, a combination of two or more different materials, two or more compounds of similar materials, or two or more grades of the same material could be used.

As indicated above, flexible wall 408 can extend in a generally longitudinal direction between opposing ends 404 and 406. Additionally, flexible wall 408 can include an outer surface 410 and an inner surface 412 with the inner surface at least partially defining spring chamber 402 of gas spring assembly GS1. Flexible wall 408 can include an outer or cover ply (not identified) that at least partially forms outer surface 410. Flexible wall 408 can also include an inner or liner ply (not identified) that at least partially forms inner surface 412. In some cases, flexible wall 408 can further include one or more reinforcing plies (not shown) disposed between outer and inner surfaces 410 and 412. The one or more reinforcing plies can be of any suitable construction and/or configuration. For example, the one or more reinforcing plies can include one or more lengths of filament material that are at least partially embedded therein. Additionally, it will be appreciated that the one or more lengths of filament material, if provided, can be oriented in any suitable manner. As one example, the flexible wall can include at least one layer or ply with lengths of filament material oriented at one bias angle and at least one layer or ply with lengths of filament material oriented at an equal but opposite bias angle.

Flexible spring member 400 can include any feature or combination of features suitable for forming a substantially fluid-tight connection with end member assembly 300 and/or suitable for forming a substantially fluid-tight connection with end member assembly EM1. As non-limiting one example, flexible spring member 400 can include open ends that are secured on or along the corresponding end member assemblies by way of one or more crimp rings 414 and 416. Alternately, a mounting bead (not shown) can be disposed along either or both of the ends of the flexible wall. In some cases, the mounting bead, if provided, can, optionally, include a reinforcing element, such as an endless, annular bead wire, for example. In some cases, a restraining cylinder 418 and/or other components can be disposed radially outward along flexible wall 408. In some cases, such components can be secured on or along the flexible wall in a suitable manner, such as by way or one or more backing rings 420, for example.

As mentioned above, gas spring and damper assembly AS1 can be disposed between associated sprung and unsprung masses of an associated vehicle in any suitable manner. For example, one component can be operatively connected to the associated sprung mass with another component disposed toward and operatively connected to the associated unsprung mass. As shown in FIGS. 2-4, for example, end member assembly 300 can include one or more fasteners 302 operable to secure end member assembly 300 on or along upper structural component USC, such as associated vehicle body BDY in FIG. 1, for example. Damper assembly DP1 can be operatively connected to the upper structural component by way of end member assembly 300, and can be operatively engaged with the end member assembly in any suitable manner. For example, damper assembly DP1 can include a bushing 246 supported on or along end member assembly 300 and to which damper rod assembly 202 is secured, such as by way of a connector 248 engaging connection structure 230 along end 212 of elongated damper rod 216, for example. Bushing 246 can be supported on or along end member assembly 300 and can be operatively secured thereto in any suitable manner. As a non-limiting example, bushing 248 could be captured between end member assembly 300 and an end cap 250 that can be secured on or along the end member assembly in a suitable manner, such as by way of a retaining ring 252, for example.

It will be appreciated that gas spring and damper assembly AS1 is displaceable, during use in normal operation, between extended and compressed conditions. In some cases, one or more jounce bumpers can be included to inhibit contact between one or more features and/or components of assembly AS1. For example, damper assembly DP1 can include a jounce bumper 254 positioned on or along elongated damper rod 216 within spring chamber 402. It will be appreciated that the jounce bumper, if provided, can be supported in any suitable manner. As a non-limiting example, jounce bumper 254 can be supported on or along end member assembly 300 and dimensioned to contact end ED1 of end member assembly EM1 during a jounce condition of assembly AS1. It will be appreciated, however, that other configurations and/or arrangements could alternately be used.

End member assembly EM1 is of a type and kind commonly referred to as a roll-off piston or piston assembly. It will be appreciated that, in accordance with the subject matter of the present disclosure, end member assembly EM1 can include any suitable number of two or more components and/or parts. For example, in the arrangement shown and described herein, end member assembly EM1 includes an end member component 500 that includes a component wall 502 that is at least partially formed from a polymeric material. End member assembly EM1 also includes an end member component 600 that extends axially coextensively along end member component 500. End member component 600 is formed as a unitary body or mass of material. End member component 600 extends continuously and uninterrupted (i.e., endlessly) around the periphery of end member component 500. Through such a construction, end member component 600 is permanently attached (i.e., inseparable without damage, destruction or material alteration of at least one of the component parts) to end member component 500. In some cases, end member component 600 can, optionally, be radially coextensive or otherwise radially interengaged with end member component 500.

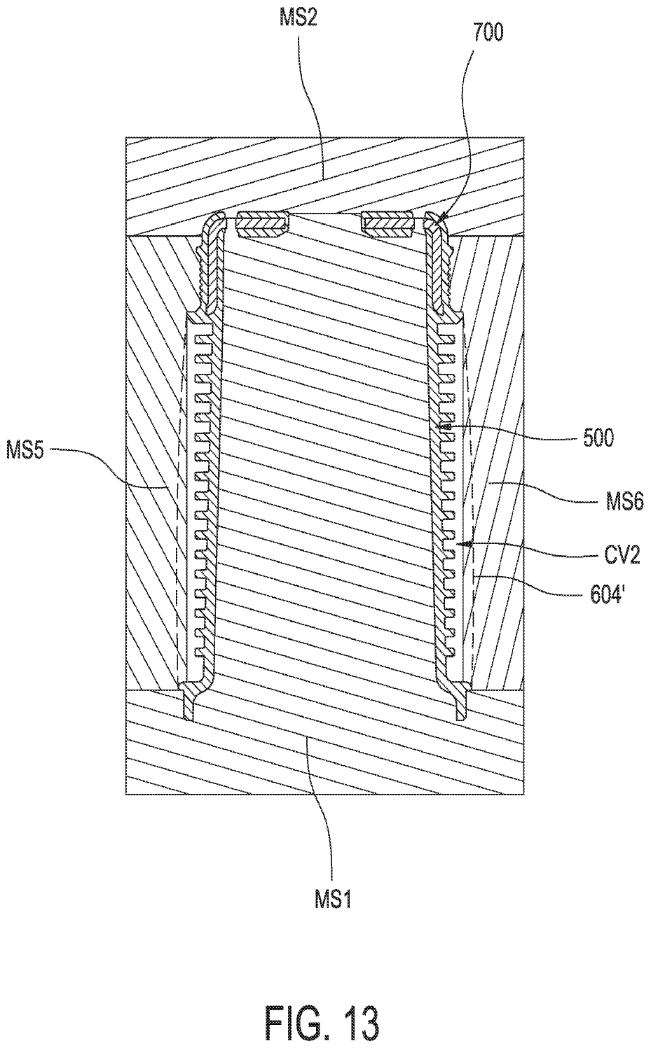

End member component 600 can include a component wall 602 that is at least partially formed from a polymeric material. Component wall 602 can include an outer surface portion 604 along which a rolling lobe 422 of flexible spring member 400 can be displaced as gas spring and damper assembly AS1 is displaced between compressed and extended conditions. It will be appreciated that outer surface portion 604 can have any one of a wide variety of different sizes, shapes and/or configurations (e.g., outer profiles with different combinations of contours and/or shapes), such as are collectively represented in FIG. 13 by dashed line 604′.

Optionally, end member assembly EM1 can include an end member component 700 that can be at least partially embedded within end member component 500. End member assembly EM1 can, optionally, further include an end member component 800 that is secured on or along end member component 500. In some cases, end member component 800 can be permanently attached (i.e., inseparable without damage, destruction or material alteration of at least one of the component parts) in spaced relation to end member component 600 though it will be appreciated that other configurations and/or arrangements could alternately be used without departing from the subject matter of the present disclosure. Additionally, it will be appreciated that end member components 500, 600, 700 and 800 can be formed from any suitable material or combination of materials, and can include any suitable number or combination of one or more walls and/or wall portions. For example, end member components 500, 600 and 800 can each be formed from a suitable combination of one or more polymeric material or combination of polymeric materials, such as a fiber-reinforced polypropylene, a fiber-reinforced polyamide, or an unreinforced (i.e., relatively high-strength) thermoplastic (e.g., polyester, polyethylene, polyamide, polyether or any combination thereof), for example. As another example, end member component 700 can be at least partially formed from a comparatively high strength and/or rigid material, such as a metal material, for example. In such cases, end member component 700 can, if included, function to strengthen or otherwise reinforce at least a portion of end member component 500.

Component wall 502 of end member component 500 can, optionally, include an end wall portion 504 that is oriented transverse to longitudinal axis AX and disposed toward end ED1 of end member assembly EM1. Component wall 502 can also include a side wall portion 506 that extends axially from along end wall portion 504 to a distal edge 508 disposed toward end ED2 of the end member assembly. Side wall portion 506 includes an inner surface portion 510 that at least partially defines an end member chamber 512 within end member assembly EM1. In some cases, one or more of end member components 600, 700 and/or 800 can be disposed in fluid communication with and/or at least partially define end member chamber 512.

Optionally, component wall 502 can further include an inner side wall portion 514 that extends axially from along end wall portion 504 to a distal edge 516. If included, inner side wall portion 514 can be disposed radially inward of side wall portion 506 such that a gap or space 518 is included radially therebetween. In some cases, a plurality of longitudinal ribs 520 can project radially inward from along inner side wall portion 514, such as may be dimensioned to abuttingly engage outside surface portion 228 of housing wall 208, for example, in assembled condition of gas spring and damper assembly AS1. A plurality of annular grooves 522 can be disposed on or along side wall portion 506, such as may be dimensioned to receivingly engage end 406 of flexible spring member 400 together with crimp ring 416, for example.

Component wall 502 can also, optionally, include a plurality of annular ribs 524 that extend around longitudinal axis AX and project radially outward to rib end surface portions 526. If included, annular ribs 524 are disposed in axially-spaced relation to one another along side wall portion 506 such that a plurality of rib root surface portions 528 are disposed along the side wall portion with one of rib root surface portions 528 disposed between adjacent ones of annular ribs 524.

Component wall 502 can also, optionally, include an attachment wall portion 530 disposed toward distal edge 508. Attachment wall portion 530 can be dimensioned to cooperatively engage end member component 800 (if included), such as to permanently attach (i.e., inseparable without damage, destruction or material alteration of at least one of the component parts) end member components 500 and 800, for example.

Component wall 602 of end member component 600 can include a side wall portion 606 on or along which outer surface portion 604 and/or 604′ are at least partially defined. Side wall portion 606 can include a distal edge 608 disposed toward end wall portion 504 of end member component 500 and/or a distal edge 610 disposed toward distal edge 508 of end member component 500.

As discussed above, end member component 600 extends continuously and uninterrupted (i.e., endlessly) around the periphery of end member component 500. That is, in a preferred arrangement, end member component is free from (i.e., without) longitudinally-extending edges or edge portions that could form a joint along the length of the component wall. In such cases, end member component 600 is permanently attached (i.e., inseparable without damage, destruction or material alteration of at least one of the component parts) to end member component 500. End member component 600 can, in some cases, be radially coextensive or otherwise radially interengaged with end member component 500.

In a preferred arrangement, component wall 602 is injection molded or otherwise formed from a polymeric material in situ with end member component 500. In such a construction, component wall 602 can be formed as an endless wall extending peripherally around end member component 500. In cases in which end member component 500 includes annular ribs 524, component wall 602 can be injection molded or otherwise formed so as to include a plurality of annular ribs 612 that extend around longitudinal axis AX. Annular ribs 612, if included, can project radially inward toward rib root surface portions 528 to substantially fill the spaces between adjacent ones of annular ribs 524. In this manner, annular ribs 524 and annular ribs 612 are interleaved with one another in the axial direction. Such a construction substantially inhibits axial movement between end member components 500 and 600.

If included, end member component 700 can include a component wall 702 that can include an end wall portion 704 oriented transverse to longitudinal axis AX. Component wall 702 can also include a side wall portion 706 that extends axially from along end wall portion 704 toward a distal edge 708. Component wall 702 can also include a plurality of openings or passages 710 extending through end wall portion 704.

In a preferred arrangement, end member component 700 is at least partially embedded within component wall 502 of end member component 500. In such an arrangement, openings or passages 710 extend through component wall 702 as well as through component wall 502 such that openings 710 are disposed in fluid communication with end member chamber 512, such as through gap 518 between side wall portion 506 and inner side wall portion 514, for example. In this manner, spring chamber 402 and end member chamber 512 are disposed in fluid communication through openings 710 during operation and use of assembly AS1. Additionally, in such a construction, openings 710 can remain open and in fluid communication between spring chamber 402 and end member chamber 512 during a jounce condition in which jounce bumper 254 is abutting engagement with end wall portion 504 of end member component 500. Furthermore, in a preferred arrangement, side wall portion 706 can be axially coextensive with annular grooves 522 of component wall 502.

End member 800 can include a component wall 802 that extends peripherally around longitudinal axis AX with a side wall portion 804 extending axially between an attachment wall portion 806 and a sealing wall portion 808 disposed opposite attachment wall portion 806. Side wall portion 804 can extend axially along outside surface portion 228 of housing wall 208. Attachment wall portion 806 is dimensioned for cooperative engagement with attachment wall portion 530 such as to permanently (i.e., inseparable without damage, destruction or material alteration of at least one of the component parts) attach end member components 500 and 800, for example, as discussed above. Sealing wall portion 808 is spaced radially outward of side wall portion 804 and is dimensioned to at least partially receive radial spacer 244 and/or sealing device 246.

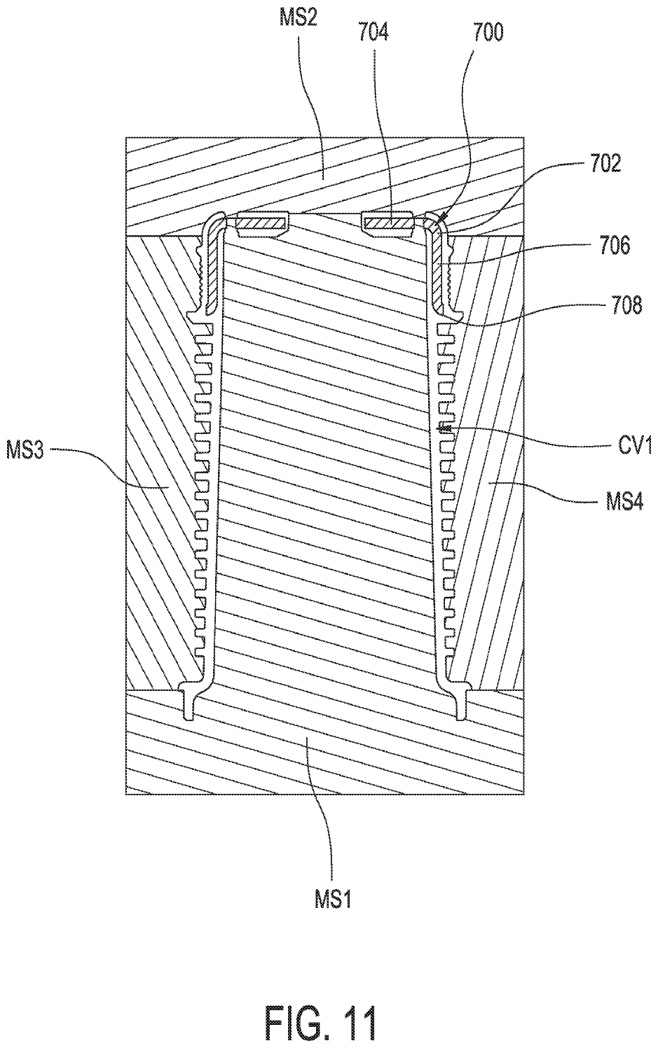

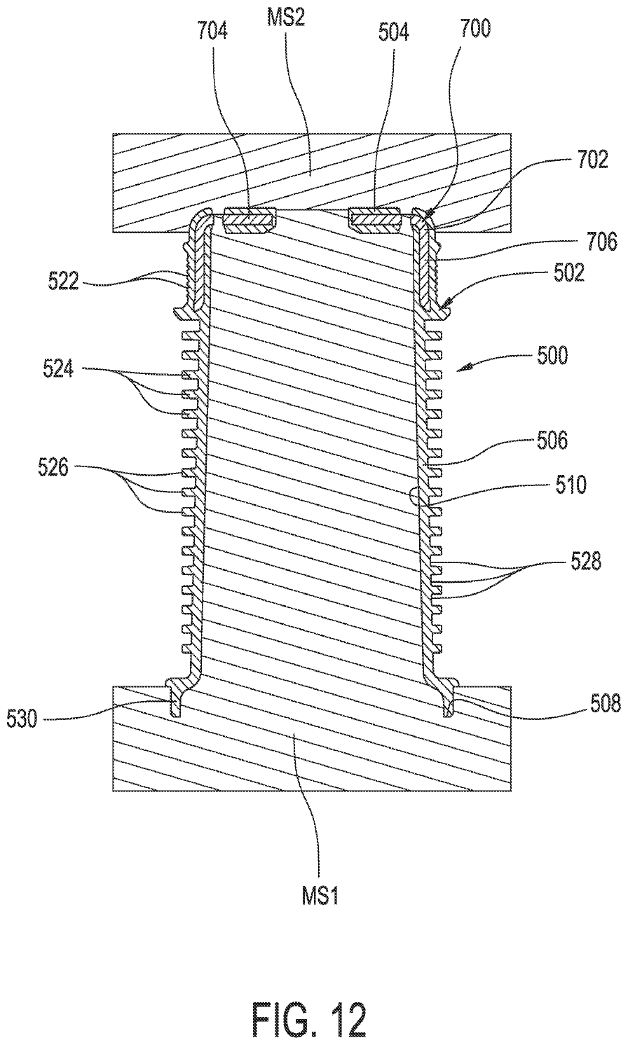

In a preferred arrangement, component wall 502 of end member component 500 can be manufactured or otherwise formed within a mold cavity CV1 of an injection mold that includes a plurality of mold sections, such as are represented in FIG. 11 by mold sections MS1, MS2, MS3 and MS4, for example. In a preferred arrangement, end member component 700 can, optionally, be positioned within cavity CV1 prior to injection molding or otherwise forming component wall 502 of end member component 500. As a non-limiting example, component wall 702 can be captured on or along one or more of the mold sections (e.g., between mold sections MS1 and MS2) to retain end member component 700 in position within cavity CV1. Component wall 502 can then be injection molded or otherwise formed from a suitable polymeric material or combination of polymeric materials, such as a fiber-reinforced polypropylene, a fiber-reinforced polyamide, or an unreinforced (i.e., relatively high-strength) thermoplastic (e.g., polyester, polyethylene, polyamide, polyether or any combination thereof), for example, to at least partially embed end member component 700 within component wall 502 of end member component 500, such as is shown in FIG. 12.

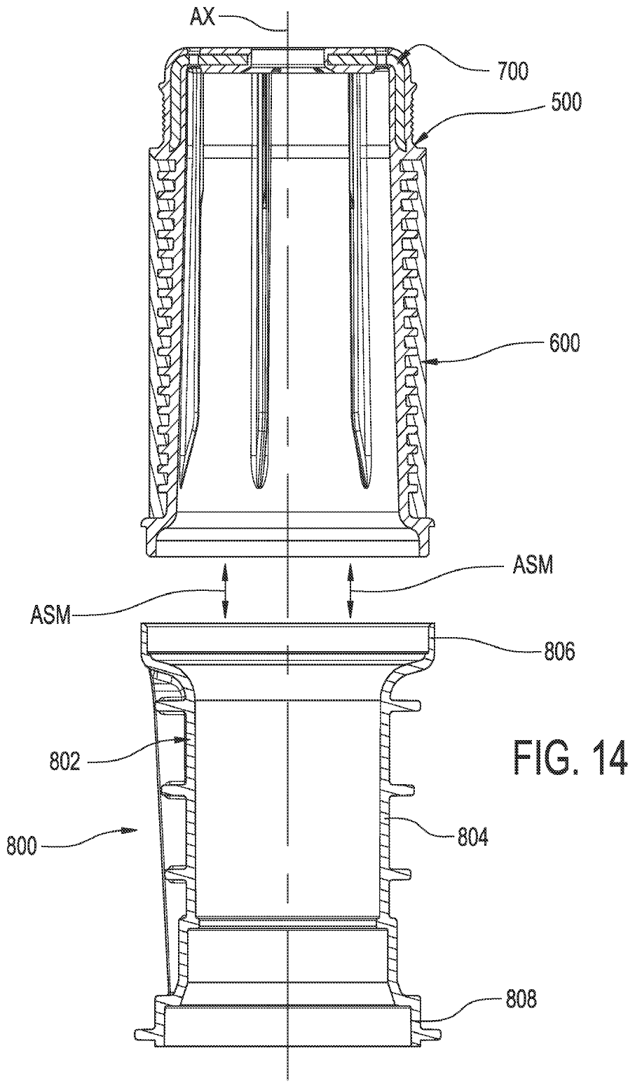

With further reference to FIG. 12, end member component 500 together with end member component 700, which is at least partially embedded within end member wall 502, is shown in situ within mold sections MS1 and MS2 with mold sections MS3 and MS4 removed to expose at least a portion of component wall 502. In FIG. 13, mold sections MS5 and MS6 are introduced that at least partially define a mold cavity CV2 around at least a portion of component wall 502. Component wall 602 can then be injection molded or otherwise formed from a suitable polymeric material or combination of polymeric materials, such as a fiber-reinforced polypropylene, a fiber-reinforced polyamide, or an unreinforced (i.e., relatively high-strength) thermoplastic (e.g., polyester, polyethylene, polyamide, polyether or any combination thereof), for example, such that end member component 600 extends peripherally around and is permanently attached (i.e., inseparable without damage, destruction or material alteration of at least one of the component parts) to end member component 500. In such an arrangement, annular ribs 612 can, optionally, flow into and substantially fill the spaces between adjacent ones of annular ribs 524 (if included) such that annular ribs 612 and 524 are interleaved with one another in the axial direction. If included, end member component 800 can, optionally, be provided separately and assembled together with the combination of end member components 500, 600 and 700, such as is represented in FIG. 14 by arrows ASM. It will be appreciated that end member component 800 can be permanently attached to the combination of end member components 500, 600 and 700 in any suitable manner, such as by way of a flowed-material joint JNT (FIG. 5), for example.

As used herein with reference to certain features, elements, components and/or structures, numerical ordinals (e.g., first, second, third, fourth, etc.) may be used to denote different singles of a plurality or otherwise identify certain features, elements, components and/or structures, and do not imply any order or sequence unless specifically defined by the claim language. Additionally, the terms “transverse,” and the like, are to be broadly interpreted. As such, the terms “transverse,” and the like, can include a wide range of relative angular orientations that include, but are not limited to, an approximately perpendicular angular orientation. Also, the terms “circumferential,” “circumferentially,” and the like, are to be broadly interpreted and can include, but are not limited to circular shapes and/or configurations. In this regard, the terms “circumferential,” “circumferentially,” and the like, can be synonymous with terms such as “peripheral,” “peripherally,” and the like.

Furthermore, the phrase “flowed-material joint” and the like, if used herein, are to be interpreted to include any joint or connection in which a liquid or otherwise flowable material (e.g., a melted metal or combination of melted metals) is deposited or otherwise presented between adjacent component parts and operative to form a fixed and substantially fluid-tight connection therebetween. Examples of processes that can be used to form such a flowed-material joint include, without limitation, welding processes, brazing processes and soldering processes. In such cases, one or more metal materials and/or alloys can be used to form such a flowed-material joint, in addition to any material from the component parts themselves. Another example of a process that can be used to form a flowed-material joint includes applying, depositing or otherwise presenting an adhesive between adjacent component parts that is operative to form a fixed and substantially fluid-tight connection therebetween. In such case, it will be appreciated that any suitable adhesive material or combination of materials can be used, such as one-part and/or two-part epoxies, for example.

Further still, the term “gas” is used herein to broadly refer to any gaseous or vaporous fluid. Most commonly, air is used as the working medium of gas spring devices, such as those described herein, as well as suspension systems and other components thereof. However, it will be understood that any suitable gaseous fluid could alternately be used.

It will be recognized that numerous different features and/or components are presented in the embodiments shown and described herein, and that no one embodiment may be specifically shown and described as including all such features and components. As such, it is to be understood that the subject matter of the present disclosure is intended to encompass any and all combinations of the different features and components that are shown and described herein, and, without limitation, that any suitable arrangement of features and components, in any combination, can be used. Thus, it is to be distinctly understood claims directed to any such combination of features and/or components, whether or not specifically embodied herein, are intended to find support in the present disclosure. To aid the Patent Office and any readers of this application and any resulting patent in interpreting the claims appended hereto, Applicant does not intend any of the appended claims or any claim elements to invoke 35 U.S.C. 112(f) unless the words “means for” or “step for” are explicitly used in the particular claim.

Thus, while the subject matter of the present disclosure has been described with reference to the foregoing embodiments and considerable emphasis has been placed herein on the structures and structural interrelationships between the component parts of the embodiments disclosed, it will be appreciated that other embodiments can be made and that many changes can be made in the embodiments illustrated and described without departing from the principles hereof. Obviously, modifications and alterations will occur to others upon reading and understanding the preceding detailed description. Accordingly, it is to be distinctly understood that the foregoing descriptive matter is to be interpreted merely as illustrative of the subject matter of the present disclosure and not as a limitation. As such, it is intended that the subject matter of the present disclosure be construed as including all such modifications and alterations.

1. An end member assembly having a longitudinal axis and dimensioned to receivingly engage an associated flexible spring member, said end member assembly extending axially from a first end toward a second end, and said end member assembly comprising:
a first end member component including a first component wall that extends peripherally about said longitudinal axis; and,
a second end member component including a second component wall formed as a unitary mass extending endlessly around said first end member component such that said second end member component is permanently attached to said first end member component.

2. An end member assembly according to claim 1, wherein said first component wall includes a side wall portion extending axially about said longitudinal axis, said side wall portion including an inner surface portion and a plurality of first annular ribs extending radially outward, said plurality of first annular ribs disposed in axially spaced relation to one another along said side wall portion of said first component wall.

3. An end member assembly according to claim 2, wherein said second component wall includes an outer surface portion with a plurality of second annular ribs disposed in axially spaced relation to one another, each of said plurality of second annular ribs axially disposed between adjacent ones of said plurality of first annular ribs such that said plurality of first annular ribs and said plurality of second annular ribs are axially interleaved with one another.

4. An end member assembly according to claim 1 further comprising a third end member component at least partially embedded within said first component wall of said first end member component.

5. An end member assembly according to claim 4, wherein said first component wall includes an end wall portion, and said third end member component includes a third component wall with an end wall portion at least partially embedded within said end wall portion of said first component wall.

6. An end member assembly according to claim 4, wherein said third end member component includes a third component wall with a side wall portion at least partially embedded within said side wall portion of said first component wall.

7. An end member assembly according to claim 4, wherein said first component wall is at least partially formed from a first polymeric material and said third end member component includes a third component wall that is at least partially formed from a metallic material and/or a second polymeric material that is different from said first polymeric material.

8. An end member assembly according to claim 4, wherein said first end member component includes a plurality of annular grooves facing radially outward in axially-spaced relation to said plurality of first annular ribs, said plurality of annular grooves dimensioned to receivingly engage an associated end of the associated flexible spring member and positioned axially coextensively with said side wall portion of said third component wall of said third end member component.

9. (canceled)

10. (canceled)

11. An end member assembly according to claim 1, wherein said first end member component is injection molded in a first cavity at least partially formed by a plurality of first mold sections, and said second end member component is injection molded around said first end member component in a second mold cavity formed by a plurality of second mold sections with said first end member component supported in situ on one or more of said plurality of first mold sections.

12. An end member assembly according to claim 1, wherein a third end member component is supported in a first cavity at least partially formed by a plurality of first mold sections with said first end member component injection molded in said first cavity and at least partially encapsulating said third end member component.

13. An end member assembly according to claim 1, wherein said first component wall includes an inner side wall portion disposed radially inward of said side wall portion such that an annular gap is disposed therebetween, said inner side wall portion including a plurality of longitudinal ribs projecting radially inward in a direction away from said annular gap.

14. (canceled)

15. An end member assembly according to claim 1, wherein said first and second end member components at least partially define an end member chamber within said end member assembly.

16. A gas spring assembly comprising:
a flexible spring member extending peripherally about said longitudinal axis and longitudinally between opposing first and second ends such that a spring chamber is at least partially defined therebetween;
an end member secured across said first end of said flexible spring member; and,
an end member assembly according to claim 1 operatively secured across said second end of said flexible spring member such that a substantially fluid-tight connection is formed therebetween.

17. A gas spring assembly according to claim 16, wherein said flexible spring member at least partially defines a rolling-lobe dimensioned for displacement along an outer surface portion of said second component wall of said second end member component as said gas spring assembly undergoes extension and compression during use.

18. A gas spring and damper assembly comprising:
a damper assembly having a longitudinally-extending axis and including:
a damper housing including a housing wall extending axially between opposing first and second ends, said housing wall at least partially defining a damping chamber containing a quantity of damping fluid; and,
a damper rod assembly including an elongated damper rod and a damper piston secured along said elongated damper rod, said damper rod assembly operatively interengaged with said damper housing for reciprocal displacement relative thereto with said damper piston disposed within said damping chamber and at least a portion of said elongated damper rod projecting axially-outwardly from said first end of said damper housing; and,
a gas spring assembly according to claim 16 disposed in axially coextensive relation with at least a portion of said damper assembly.

19. A gas spring and damper assembly according to claim 18, wherein damper housing includes an end wall portion oriented transverse to said longitudinal axis, and an end wall portion of said first component wall of said first end member component is axially supported on said end wall portion of said damper housing with an end of said end member assembly opposite said end wall portion substantially unsupported by said damper housing in both axial directions.

20. (canceled)

21. (canceled)

22. A method of manufacturing an end member assembly, said method comprising:
injecting a first quantity of polymeric material into a first mold cavity at least partially defined by first and second first mold sections thereby molding a first end member component having a longitudinal axis; and,
injecting a second quantity of polymeric material into a second mold cavity at least partially defined by said first end member component and a third mold section with said first end member component supported on at least one of said first and second mold sections thereby molding a second end member component around said first end member component.

23. A method according to claim 22, wherein molding said first end member component includes molding a first component wall that includes an end wall portion and a side wall portion extending axially from along said end wall portion, said side wall portion including an inner surface portion and a plurality of first annular ribs extending radially outward, said plurality of first annular ribs disposed in axially spaced relation to one another along said side wall portion of said first component wall.

24. A method according to claim 23, wherein molding said second end member component includes molding a second component wall that includes an outer surface portion with a plurality of second annular ribs disposed in axially spaced relation to one another with each of said plurality of second annular ribs axially disposed between adjacent ones of said plurality of first annular ribs such that said plurality of first annular ribs and said plurality of second annular ribs are axially interleaved with one another.

25. A method according to claim 22 further comprising providing a third end member component and positioning said third end member component within said first mold cavity prior to injecting said first quantity of polymeric material into said first mold cavity.

26. (canceled)
